(19) United States
(12) Patent Application Publication
(10) Pub. No.: US 2006/0006576 A1
(43) Pub. Date: Jan. 12, 2006

(54) Coiled cooling channels

(75) Inventor: Horst Karos, Bayreuth (DE)

Correspondence Address: BURR & BROWN, PO BOX 7068, SYRACUSE, NY, 13261-7068, US

(73) Assignee: Joerg GUEHRING, Albstadt (DE)

(21) Appl. No.: 11/154,279

(22) Filed: Jun. 16, 2005

Related U.S. Application Data
(63) Continuation of application No. PCT/DE03/04272, filed on Dec. 18, 2003.

(30) Foreign Application Priority Data
Dec. 19, 2002 (DE) 102 59 779.0
Dec. 20, 2002 (DE) 102 60 136.4

(51) Int. Cl. B29C 47/24

(52) U.S. Cl. 264/209.2; 425/294

(57) ABSTRACT

An extrusion press method for production of sintered blanks comprising at least one internal, spirally extending channel, the plastic material forming the blank being pressed out of the mouth of a nozzle of an extrusion press in the form of a substantially circular cylindrical pipe. The plastic material which exits from the mouthpiece of the nozzle in a substantially twist-free manner flows along the axis of at least one spirally twisted pin which is maintained in a stable position on a gudgeon of the nozzle. The pin does not rotate, the plastic material in the mouth is displaced in a twisted flow corresponding to the spiral shape of the pin and the rotational movement of the plastic material is supported by a rotationally driven section of the mouth, which is engaged on the outer periphery of the material such that the pin is essentially not subjected to bending deformation.

### CROSS-REFERENCE TO RELATED APPLICATIONS

This application claims the benefit of German Patent Application No. 102 59 779.0, filed Dec. 19, 2002, the entirety of which is incorporated herein by reference.

This application claims the benefit of German Patent Application No. 102 60 136.4, filed Dec. 20, 2002, the entirety of which is incorporated herein by reference.

This application is a continuation of International Application PCT/DE2003/004272, filed Dec. 18, 2003, the entirety of which is incorporated herein by reference.

### FIELD OF THE INVENTION

The invention relates to an extrusion press method, in particular for the production of a sintered metal blank or a ceramic blank for a tool or part of a tool, in which blank the plastic material forming the blank is pressed out of the mouthpiece of a nozzle, wherein said plastic material flows along the axis of at least one spirally twisted pin which is held by a gudgeon of the nozzle. Furthermore, the invention relates to an extrusion-pressed green compact or a sintered blank that can be produced with this extrusion press method, as well as to a cutting tool that can be produced from the sintered blank, and to a component of such a tool.

### BACKGROUND OF THE INVENTION

Cylindrical sintered blanks continuously produced for example in the extrusion press method, which sintered blanks are made from a plasticised ceramic or powdered metallurgical material, wherein said sintered blanks comprise internal channels that are arranged spirally at least in some sections and are of a predefined cross section, are increasingly used for example in the tool industry, and in the tool industry in particular in the production of drills which feature internal coolant or flushing agent supply so that the coolant or flushing agent can exit the tool in close proximity to the cutting edges. A spiral shape of the internal cooling channel, of which there is at least one, is required if in the tool to be produced, for example a drilling tool, spiral cutting grooves are provided, for example ground in.

Such high-performance tools also withstand the very considerable loads encountered for example in hard machining, dry machining, minimum quantity lubrication and high-speed machining. Furthermore, it has been recognized that the objectives of minimum quantity lubrication ability and significantly increased cutting performance are not mutually exclusive but instead can be implemented at the same time. Drilling tools which were developed for use with minimum quantity lubrication operate for example with significantly increased feed rates when compared to tools for conventional coolant lubrication. In this process the quantity of coolant supplied plays a decisive role. Nowadays, in so-called high-performance cutting (HPC) processes there are ongoing attempts to further reduce production costs, taking into account all process parameters involved. In the case of tools, apart from their production costs, it is above all the essential operating times and the service life that are decisive, and these in turn decisively depend on the achievable feed speeds and thus on the rotary speeds achievable in existing machine tools/high-performance spindles. In this context the feed speed is not only limited by the rotary speed but also by the necessity to prevent blockages in the chip removal process. Spiral tools have decisive advantages in this respect when compared to straight-grooved tools. Due to the more favourable cutting rake, the spiral design ensures better cutting performance, and the twist angle of the cutting groove ensures improved removal of the mixture comprising chips and lubricant. As far as centring accuracy is concerned, spiral tools are also advantageous because such tools can be supported in the drill hole by their entire outer periphery.

In the meantime it is not just the axial length of such drilling tools that has been significantly increased. In the latest developments there is an increased tendency to feature internal cooling channels even in very small cutting tools, in particular in drills. In such an arrangement, as far as the sturdiness of a drill is concerned, particular attention has to be paid to the particularly thin walls between the cooling channels and the spiral cutting groves. It is thus particularly important during production to precisely guide and control the pitch of the internal spirally extending cooling channel, of which there is at least one, so that the position of the cooling channel in the drill stays or tool stays is within predefined narrow tolerance ranges along the entire length of the cutting part.

In order to remove the chips from the cutting groove, the coolant has to be fed in at times at high pressure, especially in the case of deep-hole drilling, wherein the internal cooling channel i.e. the drill has to be able to withstand corresponding pressures without being destroyed. In particular as part of minimum quantity lubrication, a process which is becoming widespread, there is a desire to design the cooling channels so as to provide the largest volume possible. In addition, there is a need to be able to make ever smaller and longer drill holes. However, with increased lengths and reduced diameters of a drilling tool it becomes increasingly difficult to dimension the internal cooling channels in such a way that corresponding coolant throughput or coolant pressure is provided, without the sturdiness of the drill being negatively affected. For, the size of the cooling channels is limited by the distance to the drill back or the cutting space. If the stays are too thin, cracks and tool breakages occur. In the case of multiple-cutting tools, the cooling channels must also be spaced apart from each other by a certain minimum distance, otherwise impediments result in the face geometry of the drill, i.e. for example in the transverse cutter or in a point shape. Furthermore, there are process-imposed limits because with current powder-metallurgy processes it is impossible to produce blanks suitable for such tools.

Thus, the alignment of the internal cooling channels cannot be monitored during machining of the sintered blank. It is therefore necessary to produce the blank in such a way that the tolerances in the region of the internal channel are as close as possible in relation to cross section, to the diameter of the graduated circle and to the eccentricity of the graduated circle in relation to the axis. This has to be ensured in each radial section of the blank, which also requires that a predefined spiral pitch be maintained with great precision.

Otherwise a case may arise where, in particular during the grinding of spiral cutting grooves in sintered blanks of extended length, the groove too closely approaches the internal channel. This would either cause a reduction in strength or sturdiness, or cause the entire blank to be unusable. This problem occurs irrespective of the number of internal cooling channels or flushing agent channels in the drill, and irrespective of the shape of these channels. As a further aspect in the production of metal blanks or ceramic blanks it must be taken into account that during the drying phase and/or sintering phase, the blanks can be subject to considerable shrinkage which regularly depends on the microstructure. It is thus crucial in the extrusion of the plasticized hard metal material or ceramic material to take measures which will ensure that the extruded blank cannot only be produced with great dimensional accuracy, but also with a high degree of microstructural homogeneity across the cross section.

Known methods only inadequately meet these requirements. Thus, already U.S. Pat. No. 2,422,994 describes an extrusion press method in which a plasticised powder-metallurgical material is pressed through an extrusion press nozzle whose internal surface comprises projections in the shape of the cross section of the cutting groove. In the region of the center of the extrusion pressed nozzle, straight bar-shaped bodies extend in an axial direction, which bodies are attached to a gudgeon that is positioned upstream of the extrusion press nozzle, with the plasticized material flowing around said gudgeon. This is a multi-stage process in that the plasticized raw material is first shaped to form a drill blank which comprises at least one straight outside groove that corresponds to the shape of the cross section of the cutting groove, and comprises at least one straight bar which corresponds to the shape of the cross section of the cooling channel. In a second step the green compact designed in this way is twisted by a relative rotational movement of the extrusion press nozzle in relation to the raw material. In this process a blank in the shape of a spirally twisted helix with an impressed internal channel is generated. However, it is a requirement of modern cutting tools that the tool shaft except for embossed internal cooling channels comprises a fully cylindrical material—because only in this way is it possible to ensure complete introduction of the coolant into the cooling channel or cooling channels. The cutting part produced from the spirally twisted helix blank thus has to be soldered onto a separate fully cylindrical shaft. Apart from increased production costs this also results in reduced stability of the tool. Furthermore, it has been shown that for most of the blank materials used in the meantime, such a two-stage shaping process is not feasible, if for no other reason because the blank emanating from the extrusion press nozzle is frequently pressure-sensitive to such an extent that even the most minute forces acting on it lead to an undesirably high degree of deformation not only of the external contour but also of the internal channels which are formed, so that consequently the rate of rejects rises excessive.

In the meantime, many attempts have been made to find an economical extrusion press method with which fully cylindrical bar-shaped blanks can be produced which make possible the production of single-piece tools with spiral cutting grooves that are worked in subsequently.

To this effect, DE-PS 36 01 385 already presents a method for producing a drill tool which comprises at least one spirally extending internal cooling channel, in which the spiral shape of the internal cooling channel, of which there is at least one, is produced at the same time as the plastic material is extruded. To this effect, the inside of the mouthpiece of the nozzle comprises a spiral-shaped profile, wherein the spiral pitch of these projections matches the desired spiral pitch of the internal cooling channels. Elastic pins are provided in the center of the extrusion press nozzle, with the upstream ends of said pins being attached to a gudgeon of the nozzle, and the elasticity of said pins being selected so that the pins can follow the twist flow induced by the internal contour of the mouthpiece of the nozzle. Quite apart from the fact that this type of production requires a relatively large quantity of energy in order to impart a homogeneous twist flow to the entire flow cross section, it has been shown that in the case of blanks produced according to this known method the pitch of the cooling channel spirals frequently deviates from the spiral pitch of the projections or indentations on the internal surface of the mouthpiece of the nozzle. This has resulted in the projections or indentations on the interior surface of the mouthpiece of the nozzle having to be produced in large quantities but with relatively shallow depth so as to keep material losses as low as possible. Correspondingly, the outside of the final-sintered parts is commonly first subjected to cylindrical grinding before the cutting grove is produced.

In order to save the process step of cylindrical grinding of the final-sintered cutting part blanks, DE-OS 40 21 383 and EP 0 465 946 A1 propose a method in which the internal surface of the mouthpiece of the nozzle is formed by the lateral surface of a circular cylinder. In this arrangement a twist device which is situated within the material flow is arranged upstream of the mouthpiece of the nozzle. According to an alternative, by means of this twist device a twist movement which acts evenly across the cross section of the extrusion is imparted to the extrusion press material, while according to a second alternative a twist movement or rotary movement is imparted to the twist device by the extrusion press material. In order to form the internal channels, thread-shaped material projects into the material flow, which thread-shaped material follows the twist movement or rotary movement. In this case the circular diameter onto which the cross sections or cross section of the internal cooling channel, of which there is at least one, come to rest in the extruded blank, is influenced by the flow speed and by the frictional losses in the mouthpiece of the nozzle, which can have a negative effect in particular when the extrusion press material is changed from one batch to another. Therefore, a further variant of this method proposes that the mouthpiece of the nozzle be designed so as to be rotatable, wherein the rotary movement of the mouthpiece of the nozzle is to result in a correction of the twist movement of the material flow.

However, since acquisition of the necessary correction can only take place in a region arranged downstream of the nozzle, dead time inaccuracies cannot be avoided. Furthermore, relaxation movement of the extrusion pressed material acting counter to the direction of twist of the twist device after the material has exited the nozzle, which relaxation movement depends on the individual characteristics of the respective material batch, renders the method difficult to control so that inaccuracies in the position of the helix, determined by the threads, of the internal channels cannot be avoided. Moreover, only material that has a round cross section of flow can be suspended in the flow as a material that forms a cooling channel cross section. If material that does not have a round cross section of flow were to be used, it would not be possible to define how the material suspended in the flow is to come to rest on the flow cross section.

Document EP 0 431 681 A2 further discloses a process and a device for producing a cylindrical blank of the type mentioned in the introduction, which blank is made from metal or ceramics, in which blank at least one twisted center pin made of a rigid material extends through the center of a circular cylindrical mouthpiece of the nozzle which is smooth on the inside. This twisted center pin, of which there is at least one, is attached, upstream of the inflow region of the mouthpiece of the nozzle, to a stationary gudgeon. Thus in this method the pins are preformed in a spiral shape and are formed from a rigid material such as, for example, hard metal or steel. In the case of a particular relatively small ratio between the internal diameter of the mouthpiece of the nozzle and the external diameter of the center pin, of which there is at least one, it is possible to do without additional twist devices. In this arrangement there is an approximation that the rigid center pins are able to impart an even twisting movement to the material flow across the entire cross section. In the case of larger values of the above-mentioned ratio, twisting of the blank has to be enhanced by additional twisting aids in the form of guide vanes in the nozzle, which guide vanes impart a twisting direction to the flow. It has also been shown that it is regularly necessary to twist the center pins more strongly than the twist of the spiral channels which will then actually be present in the blank. For each extrusion press material this necessitates comprehensive trials which render the processing method more expensive and necessitate extensive quality assurance measures.

In order to produce extrusion press blanks with a precisely defined arrangement of internal spirally extending cooling channels with the maximum degree of reproducibility and with top quality microstructure—with no limitations whatsoever in relation to the area of application of the method with regard to the composition of the extrusion press material, the process parameters or the geometry of the blank, furthermore in the applicant's own patent DE 42 11 827 it is proposed that the internal channels be produced without plastic deformation of the material situated in the mouthpiece of the nozzle in the master forming process, wherein preferably the material enters the mouthpiece of the nozzle essentially without twisting action, across the entire cross section of flow either flowing around the pin, of which there is at least one, and when passing the mouthpiece of the nozzle imparting a continuous rotary movement to said pin, with the rotary movement corresponding to the pitch of its spirals, or flowing past a pin suspension which can be driven depending on the flow speed.

According to one variant the device is characterized in that the pin, of which there is at least one, is connected in a nonrotational and axially rigid way to a shaft that is held in the gudgeon of the nozzle so as to be rotatable parallel to the axis of the nozzle, and is twisted such that the plastic material which flows along said pin imparts to said pin a rotary pulse which is essentially constant along the entire length, wherein said rotary pulse is defined by the pitch of the spirals of said pin. The associated extrusion press head is shown in FIG. 1 to which reference is made at this stage already.

According to a further variant, the shaft which carries the pin, of which there is at least one, with the connection point of said shaft to the pin in the mouth of the nozzle being positioned radially within the pin, comprises an additional drive, wherein in this case the pin can be flexible and the drive can be controllable irrespective of the desired pitch. According to an improvement shown in the additional patent specification DE 42 42 336, the pin around which the extrusion press material flows is additionally exposed to the flow of a friction-reducing fluid.

This arrangement basically moves away from the idea of imparting a twisting movement, which corresponds to the spiral pitch to be produced, to the highly viscous material flow during extrusion, thus plastically deforming the material to a relatively high degree. The method functions in the way of a reverse corkscrew effect wherein the corkscrew spiral represents the pin along which material flows, and the cork represents the plastic extrusion press material. In this arrangement the internal spiral, of which there is at least one, is created in the master form process. In this way great precision of the cooling channel is achieved in relation to the pitch, radial position, angular position and cross section. In this arrangement, in principle the option of producing cylindrical extrusion press bodies with spirally extending cooling channels has already been mentioned, which cooling channels have a cross-sectional shape other than a circular shape, for example a rectangular, polygonal or elliptical shape.

It has however been shown that this method—in particular in the case of small nominal diameters and in the case of cross-sectional areas of the cooling channel that are large in relation to the nominal diameter—does not lead to success because the energy of the flow of the extrusion press material is in this case inadequate to impart a rotary movement to the rigid pin or pins, and thus inadequate to impress corresponding spiral cooling channels into the extruded green compacts. On the contrary, straightening of the spiral pins may occur.

### BRIEF SUMMARY OF THE INVENTION

It is thus the object of the invention to improve the above-mentioned method so that fully cylindrical sintered blanks with impressed spirally extending cooling channels can be produced with great precision even in the case of cooling channel geometries that are difficult to produce, and to create a sintered blank, a cutting tool that can be produced thereof, and a component of such a tool which meets the requirements of today's production tasks.

In relation to the method, this object is met with the characteristics of the subject matter encompassed by the present claims.

According to the invention, a method is proposed for producing fully cylindrical extrusion press green compacts or sintered blanks comprising at least one spirally extending impressed channel. Such blanks are for example required in the production of drill tools. In the extrusion press method according to the invention the plasticized material in the extrusion press head first flows in an essentially twist-free manner into a nozzle inlet and thereafter is pressed along the longitudinal axis of the pin, of which there is at least one, which pin is stably attached to the gudgeon of the nozzle, in the mouthpiece of the nozzle before being pressed through the exit aperture.

In this arrangement the mouthpiece of the nozzle comprises a circular cylindrical, preferably essentially smooth, surface so that the blank being produced has a fully cylindrical external contour. The pin along which the material flows does not rotate with the material but instead protrudes rigidly into the nozzle. Preferably said pin is attached to the gudgeon of the nozzle so as to be nonrotational. As an alternative to this, for producing the sintered blanks according to the invention, any existing arrangement can be used in which the pin while being rotationally held on the gudgeon of the nozzle nonetheless does not rotate as well, due to the small nozzle cross section or the large pin cross section in relation to the nozzle cross section. In this arrangement, not only as a result of the pitch of the spirals of the pin, but also as a result of a rotating section of the nozzle, a radial component is induced by a rotating section of the nozzle.

In this way an overall helical flow is achieved which, if the rotary speed is attuned, flows on the rotating section in relation to the pitch of the spiral shape of the pin protruding into the mouth of the nozzle in such a way that the flow of the extrusion press material essentially follows the spiral pitch, i.e. that the particles at radial height of the pin have a flow direction which corresponds to the design of the pin, as a result of which bending-deformation of the pin or pins can be prevented despite the pin's or the pins' fixed position and nonrotational arrangement. Furthermore, plastic deformation of the extrusion press material or uneven microstructure formation or density distribution in the material can be prevented because the radial component of the flow is not imposed for example by twisting devices or deflection devices such as guide vanes etc. but is exclusively achieved by rotational movement of the rotary section of the nozzle. The radial movement of the flow is thus not caused by deflection at one of the obstacles in the way of the flow, but solely by way of the frictional forces inherent in the extrusion press material, which frictional forces cause the material to be taken along by the rotational movement of the nozzle section. As a result of this, the rotary movement induced in this way, emanating from the nozzle wall, independently extends towards the interior of the nozzle until a stationary helical flow occurs which corresponds to the pitch of the pin spirals. In this arrangement the flow establishes a relationship with the viscosity and tenacity of the extrusion press material.

The result is a microstructure of the extrusion press material that is largely free from distortion and inhomogeneities relating to density so that after the blank has been pressed from the nozzle, no subsequent twirling-on is to be feared, as is the case in a helical flow imposed by a twisting device. The method according to the invention thus makes it possible to produce green compacts with excellent helical accuracy.

In this arrangement it is advantageous if the rotary driven section of the nozzle extends along the section penetrated by the spiral pin because in this way interaction between the pin spiral and the rotary movement is ensured. By arranging the rotary driven section along a forward region of the pin and along the length of the section of the mouthpiece of the nozzle penetrated by the pin, a situation can be achieved in which the material moves in a spiral manner even before it reaches the pin, thus effectively preventing any bending of the pin. By advantageous additional lubrication of the pin, the load acting on the pin can be further reduced.

In this arrangement preferably hard metal is used for producing the extrusion press green compacts, for example on a tungsten carbide base, because hard metal tools have become widespread in production technology. In this arrangement the plasticized material for extrusion pressing is produced by constant working from a hard metal powder with the addition of a binder, for example cobalt, and a plasticizer, for example paraffin. However, the extrusion press method according to the invention could just as well be used with other sintering materials such as for example ceramics or cermet in which the cross-sectional geometry of the cooling channel can already be defined in the still soft raw material.

The proposed extrusion press method is suitable for producing extrusion press green compacts for rotary driven cutting tools, in particular for drill bits and milling cutters, for example end-milling cutters. Apart from this, said extrusion press method can also be used for producing extrusion press green compacts for step tools, for example step drills.

The extrusion process is then followed by a drying process or pre-sintering process, before the correspondingly derived blank bars are subjected to the actual sintering process. The final-sintered blanks are then regularly machined with cutting tools in that at least one spiral cutting groove is ground into the external surface of the blanks.

Due to the advantages, as presented above, of the method according to the invention it is possible to also produce blanks of small diameter and with cooling channel contours other than circular shapes, as well as comprising large cooling channel cross-sectional areas where hitherto known methods have been unsuccessful, in particular sintered blanks.

This is of enormous importance because in particular with small tool diameters it is necessary, for optimal supply of coolant, to completely use the available area on the tool stay or stays while maintaining necessary minimum wall thickness. Furthermore, conventional production methods have been hampered by method-related limits. As far as optimal use of the space available on the stay is concerned, a design of the cooling channel contours other than a circular design is gaining in importance. On the other hand, in this context attempts are being made to design the wall thickness between the cooling channel, the cutting groove and the external circumference of the tool so that they are as thin as possible. In other words, attempts are being made to produce sintered blanks with large cooling channel cross sections in relation to the cross-sectional areas of the blanks. In this context the precision of the helix, i.e. the size of the deviation from the desired helix, is decisive. This applies in particular to blanks having small diameters and large cooling channel cross sections, since in these cases the wall thickness between the cutting groove and the formed cooling channel is small so that even small deviations from the desired dimensions will result in the production of rejects.

According to the invention it is now possible, for the first time ever, to take account of these requirements relating to sintered blanks for the production of tools.

Thus, blanks according to the present invention, which blanks can be produced for the first time thanks to the method according to the invention, have a ratio of cross-sectional area of the blank to cross-sectional area of the formed-in channel or channels which in the case of one formed-in channel has a value of 20:80 or better, in particular 30:70, for example 50:50, while in the case of several formed-in channels the ratio is 20:80 or better, in particular 30:70, for example 40:60. In this context “better” refers to the largest possible cooling channel cross sections.

Blanks according to the present invention make it possible to produce tools which, when compared to tools made from conventional sintered blanks, have outstanding coolant throughput quantities. The production of such blanks has only become possible with the method according to the invention. Such large cooling channel cross sections result in an extremely thin minimum wall thickness between the internal cooling channel helix and the spiral cutting groove, which requires adherence to extremely stringent tolerance limits in relation to the channel helix. With a method using forced twisting, due to the problems inherent in the method, as described above, in relation to inhomogeneities in the plasticised material, relating to the microstructure, distortion and density, this object cannot be achieved. At best, if a large reject rate is accepted, non-reproducible random hits can be expected. In contrast to this, with the applicant's own method according to DE 42 42 336, the force necessary to drive the pin cannot be produced because the pin becomes thicker and thus harder to operate as the desired channel diameter increases, while at the same time the volume of the material that can be used to drive the pin decreases.

With the method according to the invention it is possible for the first time to also produce blanks with a diameter of less than 12 mm and with a cross-sectional contour of the cooling channel which differs from a circular contour. As described above, cross-sectional contours which deviate from a circular contour provide considerable advantages in relation to spatial use on the tool stays and thus considerable advantages in relation to optimizing lubricant supply. This is particularly important in the case of small tool diameters.

It might be possible to produce blanks with such small diameters with the known method according to EP 465 946. However, only round material that forms cooling channel cross sections can be suspended in the material flow. If shapes other than small spheres are suspended in the material flow it cannot be defined how the material suspended in the material flow comes to rest on the flow cross section. Furthermore, only relatively small cooling channel cross sections can be produced, otherwise the minimum wall thickness between the cooling channel and the cutting groove becomes so small in the tool to be produced from the blank that the helix tolerance of the cooling channels, which tolerance can be maintained with the thread method, is too large.

Furthermore, experiments have shown that with the applicant's own method according to DE 42 42 336, in the case of external diameters below 12 mm and large cooling channel cross sections, the force necessary for driving the pin cannot safely be generated (see above), while in the case of smaller dimensioning of the cooling channel cross sections and thus of the pins protruding into the material flow, the force acting on the pins quickly leads to straightening of said pins.

With future materials used for the extrusion press material, and with optimal lubrication of the pins according to DE 42 42 336 etc. the possibility of being able to produce blanks with external diameters below 12 mm using the applicant's own older method can in theory not be excluded. However, in the range below 8 mm, for example below 4 mm, the use of this method would seem to be impossible.

The blanks according to the invention are thus suitable for producing tools with enhanced coolant supply when compared to that in known tools.

To this effect, the external circumference of the sintered blanks is reground, after which the required number of spiral cutting grooves are worked in, for example ground in or milled in. The resulting tools then comprise at least one stay through which at least one spiral internal cooling channel leads, wherein the pitch of the internal cooling channel, of which there is at least one, extends synchronously in relation to the pitch of the spiral cutting groove(s), of which there is at least one.

Tools which have been produced from sintered blanks according to the present invention are in particular suitable for use as deep-hole drilling tools in the case of diameter-to-length ratios exceeding 1:5 and in those applications in particular for deep-hole drilling of steel, in which, up to now, despite poorer chip removal due to the lateral cutting rake of 0° and poorer centring accuracy (due to support in the drill hole being on one side on the side of the tool stay) it has been necessary to work with straight cutting grooves. This is because in the case of cooling channel contours other than circular contours and in the case of tool diameters below 12 mm, in particular below 8 mm, for example below 4 mm, it was not possible to produce spiral tools at the accuracy necessary for extreme loads. The same applies to tools made from sintered blanks according to the present invention.

In the case of shorter cutting tools too the increased accuracy in relation to position and area of the cooling channels on the tool stays, which increased accuracy is achieved by the extrusion press method according to the invention, contributes to ensuring optimum lubricant supply while maintaining adequate sturdiness of the tool. It is thus possible to carry out cutting tasks which cannot be carried out with today's tools, in particular with a view to smaller drill hole diameters, longer stroke lengths without intermediate withdrawals, and hard-to-cut materials such as for example carbon-fibre-reinforced sandwich materials etc.

With the tool according to the invention it is possible to cater for the trend towards ever smaller drill hole diameters, ever increasing drill stroke lengths, increased feed speeds and optimized coolant throughput. With the use of deep-hole drills for example drill holes with a ratio of drill length to diameter of up to 200:1 are drilled, in individual cases with stroke lengths of up to 100 times the diameter in one attempt and sometimes even without pre-drilling. Such tools are nowadays used for example in motor engineering and naval construction and in the production of fuel injection systems. In the latter field there is a requirement for drilling holes of very small diameters (in the region of 1 mm) with very long drill hole lengths in relation to the diameter.

In the case of tools with diameters of less than 12 mm, in particular less than 8 mm or 4 mm, for the purpose of optimizing the cross-sectional area of the cooling channel and thus ensuring an adequate supply of lubricant it is moreover advantageous if according to the present invention not only cross sections of cooling channels, which cross-sections are of other than circular shape, but also cross sections of cooling channels having preferred ratios of area relative to the cross-sectional area of the remaining material according to the present invention are provided.

In this arrangement the cutting rake at the cutting part of the drill is determined by the lateral cutting rake of the drill helix and thus by the spiral angle of the internal cooling channel formed in the sintered blank. The cutting rake has a decisive influence on chip formation and chip removal and thus depends on the characteristics of the material to be machined. In the preferred embodiments in which the blank length exceeds 300 mm, the cutting rake assumes values larger than 10°.

According to an advantageous embodiment according to the present invention, the tool is envisaged as a two-lip tool or a multiple-lip tool. For their production, in particular sintered blanks with cooling channel contours in the form of an ellipse or a trigon are suitable, as are mixed forms in which the cross-sectional contour tangentially encloses an imaginary circle, in which a cross-sectional area of the channel is symmetrical to a line extending radially from the axis of the blank, or in which the radius at the tightest curvature of the contour corresponds to 0.35 to 0.9 times the radius of the circular contour, as described herein, because with these forms the space available on the respective tool stay can be used optimally while certain minimum wall thicknesses of the cooling channel can be used. In the context of this invention, the term trigon refers to a triangular shape with slightly rounded corners with a minimum radius around 0.2 times that of the circle enclosed by the triangle.

In the case of a single-lip embodiment, in particular a kidney-shaped cooling channel design is suitable. As an alternative to this, the coolant supply can be ensured by several cooling channels which may be trigonal or elliptical in shape.

Extensive trials have shown that with a trigonal cooling channel cross section in comparison to a circular cooling channel cross section, very good use of the area available on the tool stay can be achieved while the minimum distances to the cutting groove and the external circumference of the tool can be maintained, which minimum distances are necessary to provide the required strength. However, as far as the coolant throughput and robustness of the tool are concerned, cooling channel shapes with rounded radii have been shown to be still more favourable.

It has been found that the stress occurring at the cooling channel depends on the shape of the cooling channel; it results predominantly from the stress concentration of the cooling channel at its tightest radii in the direction of the load. Furthermore, it was found that as far as the resistance is concerned with which a cutting tool, for example a drill or milling cutter, can encounter such stress peaks, i.e. in relation to its sturdiness and finally in determining whether crack formation in, or premature failure of, the tool occurs, apart from the stress peaks occurring at the cooling channel, it is the distance between the cooling channels and the cutting space and thus the position of the cooling channel on the stay that are decisive.

Extensive trials and simulations have resulted in an advantageous cross-sectional cooling channel geometry, i.e. in sintered blanks with minimum radii of the cooling channel contour ranging from 0.35 times to 0.9 times, in particular from 0.5 times to 0.85 times, preferably from 0.6 times to 0.85 times, particularly preferably from 0.7 times to 0.8 times, for example 0.75 times the radius of a circle enclosed by the contour.

In relation to a tool produced from the sintered blank, in this arrangement minimum wall thicknesses between the internal cooling channel and the external circumference of the drill, between the internal cooling channel and the cutting face, and between the internal cooling channel and the cutting flank ranging between a lower limit and an upper limit were found to be favourable, wherein the lower limit is 0.08×D for D<=1 mm, and 0.08 mm for D>1 mm; in particular 0.08×D for D<=2.5 mm and 0.2 mm for D>2.5 mm, preferably 0.08×D for D<=3.75 mm and 0.3 mm for D>3.75 mm, for example 0.1×D for D<=3 mm and 0.3 mm for D>3 mm, and wherein the upper limit is 0.35×D for D<=6 mm, and 0.4×D−0.30 mm for D>6 mm, in particular 0.2×D, preferably 0.15×D for D<=4 mm and 0.6 mm for D>4 mm.

With this experimentally determined cooling channel geometry and position of the cooling channel on the stay, results can be achieved whose extent in particular is surprisingly positive.

It has been shown that in a tool with a cooling channel profile in which the radius at the tightest curvature of the contour corresponds to 0.35 to 0.9 times the radius of the circular contour, as described herein, or wherein minimum wall thicknesses d_{AUX}, d_{SPX}, d_{SFX} between the internal cooling channel and an external circumference of the drill; between the internal cooling channel and a cutting face; and between the internal cooling channel and a cutting flank are within a lower limit and an upper limit, wherein the lower limit is 0.08×D for D<=1 mm, and 0.08 mm for D>1 mm, D being equal to a diameter of the cutting tool, and wherein the upper limit is 0.35×D for D<=6 mm, and 0.4×D−0.30 mm for D>6 mm (W_{max, 1}), and high throughput quantities under load, dramatically lower stress loads occur than is the case in trigonal tools. The correspondingly higher mechanical strength properties of the tool according to the invention were confirmed in breakage tests. Tests were carried out in tools made from a commonly used hard metal with values of 0.5 times to 0.85 times the radius of a circle enclosed by the contour for the tightest radius of curvature. Values of 0.6 times to 0.85 times, in particular 0.7 times to 0.8 times the diameter of the enclosed circle proved particularly suitable. For example in a drill with a nominal diameter of 4 mm and a minimum radius of 0.75×the diameter of the enclosed circle, approximately 35% lower stress peaks on the side of the cooling channel facing the cutting groove with the same cross-sectional area of the cooling channel resulted. Consequently, a value of only 0.3 mm for the minimum wall thickness at that location was achieved without having to accept insufficient drill strength. In tools made from some other material, values ranging from 0.35 to 0.9×the radius may be sensible. If a material of greater ductility and thus greater stress resistance, in particular tensile stress resistance, is used, for example minimum radii of curvature down to 0.35×the radius of the enclosed circle can return advantageous results. Even in tools which are exposed to particular load states such dimensioning can be sensible.

Apart from the reduced stress concentration due to the relatively gentle roundings when compared to conventional trigon profiles, there is an additional effect in that the position of the cooling channel contour which is most curved is moved away from the position at which the wall of the stay is thinnest. Consequently, the wall is relatively thick and thus resistant to breakage at the position where the stress is greatest.

In a tool featuring the cooling channel geometry according to the invention the throughput quantities increase almost proportionally to the cross-sectional area when compared to a tool with round cooling channel geometry, wherein the increase in the stress concentration with an increase in the cross-sectional area in the region of the cooling channel geometry according to the invention is surprisingly small when compared to the increase in conventional trigon profiles. Thus, with the cooling channel profile according to the invention, cross-sectional areas can be implemented which in the case of a round profile with the same coolant throughput would lead to tool failure due to insufficient wall spacing.

Tests have shown a correlation between adequate wall thickness and nominal diameter, which correlation in the case of small tool diameters is linear to an increase in tool diameters. Tests have shown the following wall thicknesses to be of adequate strength where the coolant supply is extreme: wall thicknesses above a lower limit of 0.08×D for D<=2.5 mm, and 0.2 mm for D>2.5 mm; preferably 0.08×D for D<=3.75 mm, and 0.3 mm for D>3.75 mm, for example 0.1×D for D<=3 mm and 0.3 mm for D>3 mm, wherein D designates the nominal diameter. Thus the above-mentioned tested drill with a nominal diameter of 4 mm for example had a wall thickness of 0.3 mm.

Due to the favourable cooling channel design from the point of view of stress distribution in the tool stay, even with such thin walls, great tool strength and thus a long service life can be achieved. In individual cases it might even be adequate to provide minimum wall thicknesses of 0.08 mm for D>1 mm.

On the other hand, the minimum wall thickness is limited towards the top only by the desired throughput quantity. In this context the following values have proven to be suitable maximum values up to which such a cooling channel contour is sensible: 0.35×D for D<=6 mm, and 0.4×D−0.30 mm for D>6 mm, in particular 0.333×D for D<=6 mm and 0.4×D−0.40 mm for D>6 mm, preferably 0.316×D for D<=6 mm and 0.4×D−0.50 mm for D>6 mm, particularly preferred 0.3×D for D<=6 mm and 0.4×D−0.60 mm for D>6 mm, for example 0.2×D or 0.15×D for D<=4 mm and 0.6 mm for D>4 mm.

It has been shown that the cooling channel geometry in which the radius at the tightest curvature of the contour corresponds to 0.35 to 0.9 times the radius of the circular contour, as described herein, is in particular suited to smaller tools in which the usage of space on the tool stay, which usage is optimized with a view to strength and coolant throughflow, is particularly important. These findings are reflected in the upper limits for minimum wall thicknesses of 0.35×D for D<=6 mm, and 0.4×D−0.30 mm for D>6 mm (W_{max, 1}), which upper limits increase more markedly above a certain nominal diameter when compared to the region of smaller diameter values.

In particular it has been shown that above diameters of 6 mm, a linear increase in the cooling channel cross-sectional areas with the nominal diameter makes sense only in the case of individual application cases, such as e.g. in the case of deep-hole drills, because the lubricant requirement can be covered also in the case of underproportionally increasing cooling channel cross sections. Of course it can also make sense in the case of larger diameter values for the minimum wall thickness to approach the lower limit of 0.08×D so as to achieve an excellent coolant supply while providing adequate strength.

The values in relation to the upper limit of the minimum wall thicknesses reflect this consideration, wherein the design of the cooling channel contour in particular in the case of minimum wall thicknesses in the region below 0.2×D is sensible. In particular in the minimum wall thickness region below 0.15×D for D<=4 mm and 0.6 mm for D>4 mm the increase in throughflow achieved by the form and dimensioning, according to the invention, of the cooling channels in relation to the available design space while maintaining good tool strength has been shown to be surprisingly favorable.

However, the fact that often tools of different diameters are produced from sintered blanks of the same diameter should be taken into account. In other words, for example tools with nominal diameters of 4 mm, 5 mm and 6 mm are produced from a blank with a diameter of 6.2 mm. In the case of the 6 mm tool with the same cooling channel design as that of the 4 mm tool, the minimum wall thickness between the cooling channel and the external circumference of the tool would thus be larger by 1 mm. Under this production-technology aspect, upper limits for the wall thickness of 0.35×D for D<=6 mm and 0.4×D−0.30 mm for D>6 mm, in particular 0.333×D for D<=6 mm and 0.4×D−0.40 mm for D>6 mm, preferably 0.316×D for D<=6 mm and 0.4×D−0.50 mm for D>6 mm, particularly preferred 0.3×D for D<=6 mm and 0.4×D−0.60 mm for D>6 mm are still in a region where the cooling channel geometry according to the invention provides advantages.

At this point it should be mentioned that the minimum wall thicknesses between the cooling channel and the external circumference of the drill or the cutting face or cutting flank can of course be selected so as to be different. From the point of view of strength, in particular the minimum distance or the minimum wall thickness between the cooling channel and the cutting face is decisive; said minimum distance can thus be larger in relation to the minimum wall thickness between the cooling channel and the cutting flank. Similarly, in relation to the minimum wall thickness between the cooling channel and the external circumference of the drill, the minimum wall thickness between the cooling channel and the cutting face can be provided with larger values in order to take account of the increased requirement concerning strength. On the other hand, for example in the case of the above-mentioned production aspect, which is relevant in practical applications, where blanks of identical diameter are used for tools of different diameters, there may be a minimum wall thickness between the cooling channel and the external circumference of the drill, which minimum wall thickness is greater than that between the cooling channel and the cutting face.

With the advantageous cooling channel profile in which the radius at the tightest curvature of the contour corresponds to 0.35 to 0.9 times the radius of the circular contour, and the minimum wall thicknesses between the internal cooling channel and an external circumference of the drill; between the internal cooling channel and a cutting face; and between the internal cooling channel and a cutting flank are within a lower limit and an upper limit, wherein the lower limit is 0.08×D for D<=1 mm, and 0.08 mm for D>1 mm, D being equal to a diameter of the cutting tool, and wherein the upper limit is 0.35×D for D<=6 mm, and 0.4×D−0.30 mm for D>6 mm (W_{max, 1}), it is thus possible to utilize the available design space on the stay or stays of a rotary cutting tool such that both the coolant throughput and the strength values are optimal.

Drills with the rounded cooling channel profile can thus withstand high load values without being destroyed over long service lives both when subjected to loads by pressure forces and torsional forces (as they are typical during drilling) and when subjected to transverse loads and loads resulting from moments of flexion (as they occur during entry into the workpiece to be machined). Similar transverse loads and loads resulting from moments of flexion also occur with cut-down milling machines or opposed milling machines. On the other hand, the achieved coolant throughput meets the stringent requirements in relation to quantity and pressure drop along the length of the tool.

Due to the low stress concentration in the case of the rounded cooling channel geometry it is thus possible to reduce the minimum wall thickness between the cooling channel and the cutting face, as a result of which the cross section of the cooling channel, and thus the throughput, increase correspondingly.

The effect wherein due to the large radii a favorable hydraulic radius, i.e. a large cross-sectional area of the cooling channel in relation to the enveloping lateral surface of the cooling channel, results, contributes to an increase in the coolant throughput with a reduction in the pressure drop. The average flow speed, which significantly depends on the frictional force in the pipe and the counterforce generated by the pressure drop, is thus greater than that of conventional trigon profiles so that with the same cross-sectional area greater throughput is achieved.

The rounded cooling channel geometry is thus particularly suited to tools where the conflict between adequate coolant supply on the one hand and adequate strength on the other hand is particularly problematic, as a rule this is thus the case with tools of a small diameter and/or long tool length.

Advantageously, the two curvature maxima of the cooling channel cross section are on the same radial coordinate, wherein this radial coordinate is greater than or equal to the radial coordinate of the circle enclosed by the cooling channel cross section. To ensure optimum use of space, the cooling channel cross section is symmetrical to an axis extended radially to the drill axis so that the applied radius is the same on the two curvature maxima. These improvements reflect the essentially symmetrical shape of the tool stays and thus reflect the design space available for the cooling channel cross section on the stay while maintaining the minimum wall thicknesses. Apart from this, an asymmetrical shape of the cooling channel cross sections is also imaginable—in particular if widening of the stays in a radial direction on the side of the main cutter starts before widening on the side facing the back of the stay—in order to make optimal use of the available design space. Asymmetrical designs can also be considered in view of the fact that the greatest loads are experienced on the side of the cooling channel facing the main cutter, while on the side facing the back of the stay, relatively lesser loads are experienced.

An elliptical shape of the cooling channel has been shown to be particularly advantageous from the point of view of providing good coolant supply while also providing adequate tool strength. Preferred values of the ratio between the main axis of the ellipse and the secondary axis are 1.18 to 1.65, particularly preferred are 1.25 to 1.43, for example 1.43. The term ellipse in the context of the invention is not limited to a mathematically precise ellipse (x²/a²+y²/b²=1) but also to a production technology ellipse, i.e. an approximate ellipse.

In the case of elliptical cooling channel cross sections, due to the low stress concentration on the curvature maxima, the cooling channel can have a thinner minimum wall thickness between the cooling channel and the main cutter than is the case in designs where the curvature maxima are placed radially further outward because there the radii are tighter than in the elliptical design.

Apart from the elliptical cooling channel shape there are however also further tool designs which are advantageous, in particular from the point of view of production technology, in which the cooling channel contour does not describe an ellipse.

A cooling channel geometry in which the maxima of curvature are displaced towards the outside in relation to the center of the enclosed circle is advantageous from the point of view of easier control of the production process of the pins used in the extrusion press method according to the invention, which pins determine the helix of the internal cooling channels. The spiral pins used in the extrusion press method for producing the cooling channels, which pins are arranged on a gudgeon upstream of an extrusion press nozzle and thus form the cooling channels in the inflowing material, are relatively difficult to produce in elliptical shape. In contrast to the above, the production of spiral pins with outward-moved maxima of curvature is comparatively simple due to the relatively large contour sections on the inside of the wires, which contour sections are available for precise fit on a drawing form.

In this regard it is particularly advantageous if the extrusion press green compacts have been formed with a radial cooling channel contour, which comprises straight limb sections by which the wires can be safely supported in the drawing form during spiralling.

Trials and simulations have shown that with such cooling channel cross sections similarly good results in relation to stress concentration and coolant throughput can be achieved as is the case with ellipsoid cooling channel cross sections, provided adequate minimum radii and minimum wall thicknesses are maintained. Due to tighter radii on the maxima of curvature, when compared to the elliptical shape, the minimum wall thicknesses are however greater.

The sintered blanks according to the invention are not only suited to the production of complete tools but also to the production of tool components. By way of example, deep-hole drills often comprise a drill head which is locally delimited to the drill tip and a shaft which extends along the length of the drill, with the two components being soldered together. In this arrangement, the drill cutter, of which there is at least one, can either be located directly on the drill head, or a drill head with screwed-on cutting plates or changeable cutters can be used. In this arrangement the drill head and shaft have to meet quite different requirements. While wear resistance and hardness are foremost in the case of the drill head, toughness and resistance to deformation are foremost in the case of the shaft.

According to the invention, sintered blanks with geometries as recited in the present claims can also be used to produce such tool components as shafts, drill heads etc., namely in embodiments comprising one cutting groove, or in the embodiments comprising several cutting grooves.

From the point of view of stability, in the production of tools—and in particular in the production of deep-hole drills which due to their long length in relation to the diameter are subjected to very substantial loads—efforts are made to get by with an absolute minimum of soldered positions, which are prone to faults and impair strength. This requirement is met by the advantageous improvement of the cutting tool according to the invention wherein the channel has a trigonal cross-sectional contour.

The characteristics of the present invention as described herein can be combined in any desired way where this is sensible.

Moreover, the tool or tool component according to the invention can comprise the usual coatings, at least in the region of the sharp cutters. In the case of a hard-material coating, such coating is preferably a thin coating, with the thickness of the coating preferably ranging from 0.5 to 3 μm.

The hard-material coating can for example comprise diamond, preferably monocrystalline diamond. But it can also be produced as a titanium nitride or a titanium aluminium nitride coating because such coatings are deposited so as to be adequately thin. Other hard-material coatings are also imaginable, for example TiC, Ti (C, N), ceramics, e.g. Al₂O₃, NbC, HfN, Ti (C, O, N), multilayer coatings comprising TiC/Ti(C, N) TiN, multilayer ceramic coatings, in particular comprising intermediate layers of TiN or Ti (C, N), etc.

By way of an alternative to the above it is also imaginable to use sintered blanks according to the invention for the production of tools or tool components which are intended for accommodating screwed-on or soldered-on cutting plates or changeable cutters.

In addition or as an alternative it is also possible to use a soft-material coating which is present at least in the region of the grooves. Such a soft-material coating preferably comprises MoS₂.

### BRIEF DESCRIPTION OF THE DRAWING FIGURES

Below, preferred embodiments of the invention are explained in more detail with reference to diagrammatic drawings. The following are shown:

FIG. 1 shows a known extrusion press head according to the applicant's own patent DE 42 42 336;

FIG. 2 shows an extrusion press head according to one embodiment of the invention, for implementing the extrusion press method according to the invention;

FIG. 3 shows a lateral view of a sintered blank according to one embodiment of the invention;

FIG. 4 shows an isometric view of an embodiment of a tool according to the invention, comprising two stays;

FIG. 5 shows an isometric view of a further embodiment of a tool according to the invention, comprising two stays;

FIG. 6 shows possible cross-sectional geometric shapes of a tool in an embodiment comprising two stays;

FIG. 7 shows further possible cross-sectional geometric shapes of a tool in an embodiment comprising two stays;

FIG. 8 shows further possible cross-sectional geometric shapes of a tool in an embodiment comprising two stays;

FIG. 9 shows an isometric view of an embodiment of a tool according to the invention, comprising one stay;

FIG. 10 shows an isometric view of a further embodiment of a tool according to the invention, comprising one stay;

FIG. 11 shows an isometric view of a further embodiment of a tool according to the invention, comprising one stay;

FIG. 12 shows a diagrammatic cross-sectional view of a further embodiment of a tool according to the invention, comprising one stay; and

FIG. 13 shows a diagrammatic cross-sectional view of a further embodiment of a tool according to the invention, comprising one stay.

### DETAILED DESCRIPTION OF THE INVENTION

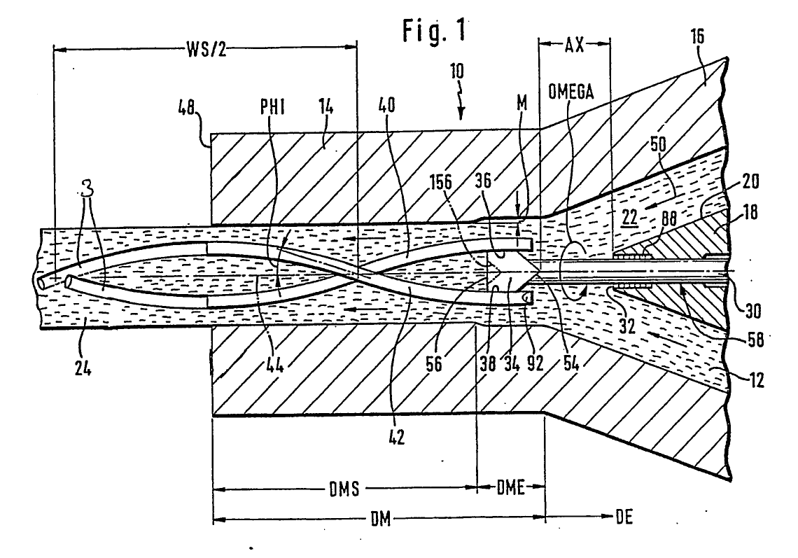

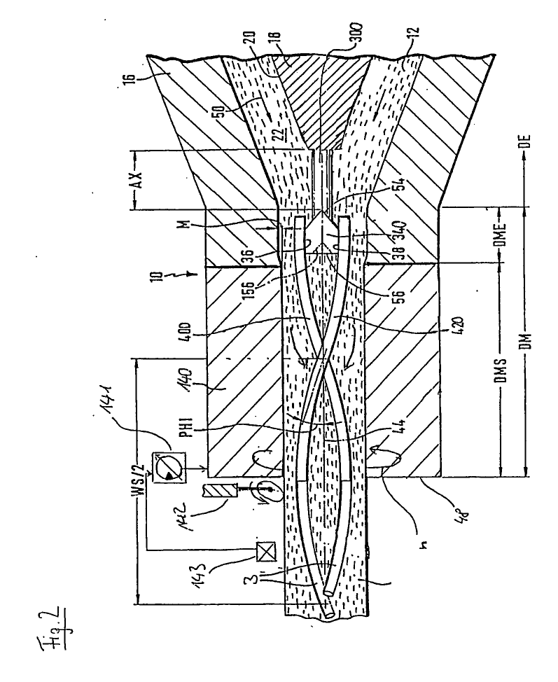

First, with reference to FIG. 1, the extrusion press method known from the applicant's own patents, e.g. DE 42 42 336, and the extrusion press head provided for it are to be explained in more detail. Then, the method according to the invention is compared to the above method with reference to the embodiment of the extrusion press head shown in FIG. 2.

In FIG. 1, reference character 10 designates an extrusion press head through which a highly viscous plasticised metal or ceramic material 12 flows from right to left. 14 designates a mouthpiece of the nozzle, which mouthpiece is made in one piece with a nozzle carrier part 16. The extrusion press nozzle comprises two sections, namely a mouth DM of the nozzle and a nozzle inlet region DE in which the plastic material 12 is fed to the mouth of the nozzle in a funnel shape. In the center of the nozzle inlet region DE, a gudgeon 18 of the nozzle is provided, which gudgeon 18 on its downstream end comprises a conical surface 20 so that between the gudgeon 18 of the nozzle and the nozzle carrier part 16, an annular space 22 is formed which leads into the mouth DM of the nozzle.

The extrusion press tool or the extrusion press head 10 or the extrusion press nozzle 14, 16 is used for continuous extrusion of cylindrical bar-shaped formed pieces 24 with at least one interior channel 3 which spirals to the left or longitudinally.

In the known extrusion press tool 10 according to FIG. 1 a shaft 30 is rotatably held in the center of the gudgeon 18 of the nozzle. The shaft 30 extends beyond the front end 32 of the gudgeon 18 of the nozzle, right into the mouth DM of the nozzle, and on the downstream end carries a plate-shaped hub piece 34 which by way of its radially outward lateral surfaces 36, 38 is firmly connected to spirally pre-twisted pins 40, 42. In this arrangement, two such pins 40, 42 are aligned so as to be point-symmetric in relation to the axis 44 of the shaft 30 and thus of the hub piece 34.

In this arrangement, the length of the pins 40, 42 essentially corresponds to half a spiral pitch WS/2, and the arrangement is such that the pins 40, 42 extend at least to the front 48 of the mouthpiece 14 of the nozzle so that the internal channels 3 which are formed by the pins 40, 42 during the extrusion process maintain their form and position outside the nozzle.

The hub piece 34 is seated in the mouth DM of the nozzle such that it is spaced apart by a predetermined axial spacing AX from the front end 32 of the gudgeon 18 of the nozzle. This axial spacing AX is preferably adjustable so as to provide the ability to influence the flow characteristics in the mouth DM of the nozzle and thus of the pin 40, 42 of which there is at least one.

As indicated by the arrows 50 in FIG. 1, the pins 40, 42 are defined and material flows along them axially in the region of the mouth DM of the nozzle. The flow thus encounters the pins 40, 42 at an angle PHI determined by the pitch WS and the diameter of the graduated circle. Because these pins 40, 42 are attached to the mouth DM of the nozzle by way of the hub piece 34 and the shaft 30 so as to be able to rotate on the axis 44, when the plastic material 12 passes through the mouth of the nozzle, said pins 40, 42 are made to rotate in a continuous movement corresponding to the pitch of the spiral of the preformed pins, with rotation being at the angular velocity OMEGA. The force components caused by placing the spirally twisted pins in the direction of flow, which force components act in circumferential direction, add up along the length of the pins 40, 42.

The arrangement comprising a rotatable shaft 30, a hub piece 34 and at least one spirally twisted pin 40, 42 carries out an even rotational movement, defined by the flow speed, of the pins 40, 42, wherein the bending load on the pins 40, 42 is kept relatively light. In this way the pins 40, 42 act according to the principle of a turbine in an axial flow with the driven shaft 30, except that the medium is not an ideal incompressible liquid but instead a highly viscous and to some extent elastic material.

Basically, the mouth of the nozzle is divided into two regions, namely a mouth of the nozzle entry region DME and a pure mouth of the nozzle flow region DMS. In the section DMS the mouth of the nozzle has a predefined cross section which essentially remains the same so that in a first approximation a constant flow speed can be assumed in this region. In the region DME, it is important that the effectively available flow-through cross section be kept constant at least along the axial length of the region DME, preferably however along the entire axial length of the mouth DM of the nozzle. To this effect the diameter in the region DME is increased in a straight line by the dimension M in relation to the section DMS so that the annular surface defined by the two diameters of the regions DMS and DME is approximately the same size as that of the cross-sectional areas of the shaft 30 and of the radial section surface of the hub piece 34 including the connection joints 52. Using a suitable design of the transitions between the interior lateral surfaces in the regions DME and DMS, excessive pressure fluctuations in the material 12 when it flows through the mouth DM of the nozzle can be eliminated. By designing the mouth DM of the nozzle so that it is straight in the transitional region between the sections DME and DMS, an excessive drop in pressure is prevented so that it can be safely ensured that the pressure in section DMS is adequate for closing the cross section.

In FIG. 1, some possible designs of the edges 54 or 56 of the hub piece 34 are indicated, which edges are situated upstream and/or downstream. Dot-dash lines indicate an alternative design of an edge 156 on the end situated downstream. With such designs the flow relationships can be influenced as desired.

If the material flows axially past the hub piece 34 and past the pins 40, 42, reaction forces also arise which act in the axial direction, which reaction forces have to be taken up by the shaft 30. For this purpose, the shaft 30 is not only held (i.e. arranged on bearings) radially but also axially.

The known extrusion press device described above operates as follows:

The highly viscous material 12 exits from the annular space 22 by way of a short inlet stretch by way of the axial distance AX into the inlet region of the mouthpiece DME of the nozzle in axial direction where, as a result of the inflow angle PHI, it causes the cooling-channel former which comprises the bars or wires 40, the hub piece 34 or 134 or 234, as well as the shaft 30 to continuously rotate in a movement which corresponds to the pitch WS of the pin spiral. The position of the spiral in the mouth DM of the nozzle and the pitch of the spiral WS exactly corresponds to the position and the pitch of the spiral of the cooling channel formed in the blank. Accordingly, when the material passes through the mouth DM of the nozzle there is no plastic deformation of the passing material, instead the internal spirally extending cooling channels are formed in a master form process. In this arrangement the bars 40, 42 are predominantly subjected to tensile forces. The same applies to the loads on the shaft 30, which shaft 30 can thus be designed to have a comparatively small diameter.

In FIG. 2, components which in form and function agree with the components shown in FIG. 1 have the same reference characters as those in FIG. 1. Below, only the design and function of the embodiment according to the invention shown in FIG. 2, which design and function differ from those shown in FIG. 1, are discussed because the above statements apply to the remaining design.

In the embodiment of the invention shown in FIG. 2, a mouthpiece 140 of the nozzle is exchangeably and rotatably supported on the nozzle carrier part 16 by way of an outward sealing friction bearing (not shown). The mouthpiece 140 of the nozzle extends along the length of the mouth of the nozzle flow region DMS of the mouth DM of the nozzle and is continuously driven by a motor 141. Reference character 300 refers to a pin which is stably and nonrotationally held in the gudgeon 18 of the nozzle, for example screwed to said gudgeon 18 of the nozzle or soldered or welded to said gudgeon 18 of the nozzle. Reference character 340 designates a fixed connection element by way of which the two spiral pins 400, 420 are connected to the pin 300 and thus to the gudgeon 18 of the nozzle.

The arrangement comprising a nonrotational pin 300, a connection element 340 and pins 40, 42 remains rigid and imparts to the inflowing material a force component acting radially in relation to the direction of flow. To this effect, the connection element 340 can comprise a design in the manner of a turbine guide vane. The resulting tendency of the mass 12 to undergo a spiral flow movement is reinforced by the rotary movement at a rotational speed n of the mouthpiece of the nozzle 140 driven by the motor 141. In this arrangement the drive speed of the motor 141 matches the flow speed of the material 12 such that the material 12 on the whole moves in a spiral flow in which the direction of movement of the mass particles at radial height of the pins 400, 420 corresponds to the spiral extension of the pins 400, 420. Impingement of the pins and thus of the connection element 340, the pin 300 and the gudgeon 18 of the nozzle, which impingement might lead to straightening of the pins or to fracturing at the soldering joint between the connection element 340 and the pins 400, 420 or the pin 300, is thus largely eliminated.

Since bending of the pins 400, 420 is thus excluded, said pins 400, 420 have exactly the same pitch that the channels in the finished extrusion press green compact are to have, as is also the case in the above-described extrusion press head of FIG. 1. In this way, any variations in the flow, for example as a result of density of the material 12 which density fluctuates from batch to batch, or as a result of similar variations, are registered and result in readjustment of the rotary speed n of the mouthpiece 140 of the nozzle.

Readjustment takes place with the use of a pitch mark arranged downstream of the nozzle by means of an indexing strip imprinted in the extruded extrusion press green compact by a rotating wheel 142. This indexing strip is impressed on the green compact at every position as a readable measure of the present pitch of the channels 3. Image acquisition 143 can acquire this dimension and correspondingly readjust the rotary speed n in the sense of a constant pitch of the channels 3 in that the motor 141 is controlled accordingly. As an alternative, controlling a gear arrangement connected between the motor 141 and the mouthpiece 140 of the nozzle is also imaginable.

In this arrangement the mouth DM of the nozzle has a smooth interior surface, also in the region of the mouthpiece of the nozzle inlet DME. The spiral flow is then solely created as a result of transverse stress induced by wall friction, with said transverse stress depending on the viscosity of the material. Said spiral flow is thus not externally enforced by any fixed twisting device or by rotating beads moving about in the material. In this way any relaxation movement of the material after exiting from the nozzle, which relaxation movement takes place against the direction of the pitch of the spiral channels, can thus be prevented so that the channels produced maintain their pitch with a high degree of constancy. In those cases where stronger rotational forces would have to act on the through-flowing material 12, it is also possible to provide surface texture or smaller driving projections at the internal circumference of the mouthpiece 140 of the nozzle.

In the embodiment shown, the rotating region of the nozzle 10 extends across the mouth of the nozzle flow region DMS of the mouth DM of the nozzle, wherein in the mouth of the nozzle inlet region DME a diameter enlargement M corresponding to the connection element 340 and pin 300 arranged therein is provided. However, it would also be imaginable to design the nozzle 10 so that it is already rotatable in the region DME. On the other hand a design is also possible where only a particular section of the mouthpiece 140 of the nozzle is rotatable or where an additional section, which extends beyond the length of the pins 400, 420, rotates as well.

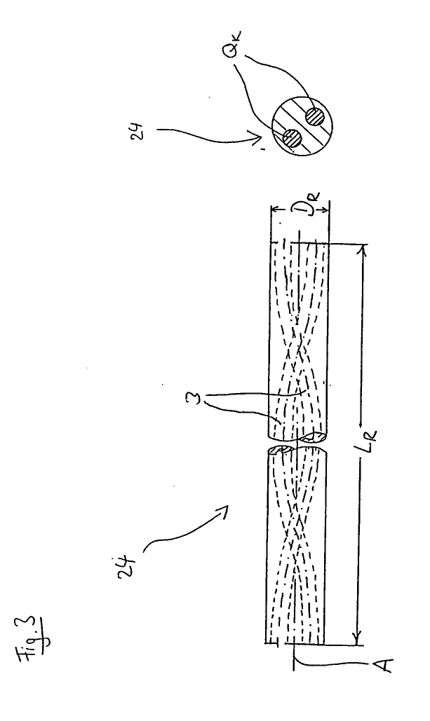

The pitch of the spirally twisted pins 400, 420 corresponds to the pitch of the channels 3 of the extruded blank 24 shown in FIG. 3. In this arrangement, the dimension of the pitch WS has to be determined taking into account the expected shrinkage during the sintering process, as is the case with the diameter of the graduated circle onto which the channels 3 come to rest.

The spiral axis A (FIG. 3) coincides with the axis 44 of the pin 300 so that—in order to obtain a cross section of the channels 3, which cross section exactly follows the cross section of the pins 400, 420—the pins 400, 420 have to be attached to the lateral surfaces 36, 38 of the connection element 340 so as to be exactly aligned; this preferably takes place by way of a welded connection or soldered connection. A material with a large E-module, such as for example steel, hard metal or a ceramic material, is used as a material for the pins 400, 420.

In the embodiment shown, two pins 400, 420 are provided. However, at this point it should be stressed that the invention is not limited to such a number and arrangement of the pins. It is also possible either to attach only one pin or several pins with evenly spaced circumferential distribution or with unevenly spaced circumferential distribution to the pin 340 or to the gudgeon of the nozzle, wherein the individual cross sections of the pins can also differ in relation to each other. It is also possible to arrange the pins on different graduated circles.

FIG. 3 shows a blank according to the invention. In this arrangement, the method according to the invention is particularly suited to small blank diameters D_{R} or to large cooling channel cross sections Q_{K} in relation to the blank diameter D_{R}. In this arrangement the pin, of which there is at least one, can have any desired cross-sectional form, wherein in the case of blanks for tools with two, three or several stays of relatively small area it makes sense for each provided stay to provide one cooling channel with an elliptical, trigonal or similar cross-sectional contour, while on the other hand in the case of tools with a relatively broad stay it makes sense to provide a cooling channel with a kidney-shaped contour or several cooling channels with a circular, elliptical or trigonal contour.

Using the method according to the invention it is possible to extrude blanks whose diameter D_{R} (FIG. 3) already essentially corresponds to the final diameter of the tool to be produced. This is because, as a result of the smooth wall of the mouthpiece 140 of the nozzle, the fully cylindrical blank obtained after extrusion pressing and final sintering needs only to be finish-polished and provided with cutting grooves. However, there is no need for any further material removal.

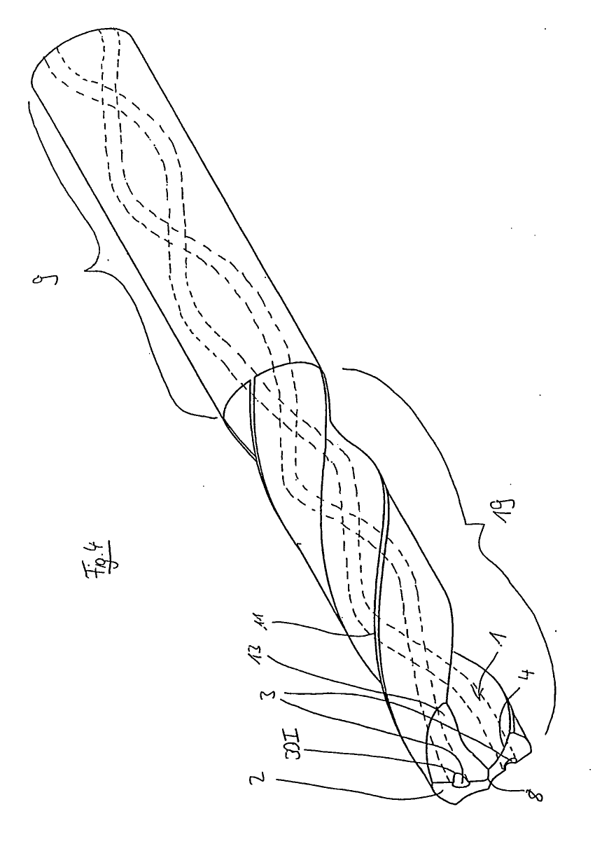

FIGS. 4 to 12 are enlarged views of various embodiments of drilling tools according to the invention with a nominal diameter of 4 mm made of a hard metal on a tungsten-carbide basis.

FIG. 4 shows an isometrically enlarged view of a spiral drilling tool with a diameter of 4 mm according to one embodiment of the invention. In this arrangement the tool comprises a main cutter 4 at each of its two stays 2, which are separated from each other by the cutting grooves 1. The cutting grooves 1 and stays 2 spirally extend at a spiral angle of approximately 30° up to a drill shaft 9, designed as a full cylinder, by which drill shaft 9 the tool can be clamped in a tool carrier or chuck. The internal cooling channels 3 extend through the entire tool and are twisted at the same spiral angle as the cutting grooves 1 and the stays 2. In the tool shown, the coolant is largely introduced directly into the cutting groove 1 because the exit surface of the cooling channels 3 extends across both sections of the free surface 13 which is divided by a so-called four-surface-grind pattern, so that the bulk of the coolant flows directly into the cutting groove 1. In order to provide circumferential support to the drill in the borehole, the drill shown in FIG. 4 additionally comprises a supporting land 11 which starts at the corner of the main cutter 4. The exit apertures of the internal cooling channels show a trigonal cooling channel cross-sectional contour 30I, which allows improved coolant delivery when compared to a circular cooling channel contour with the same minimum distance to the cutting groove 1.

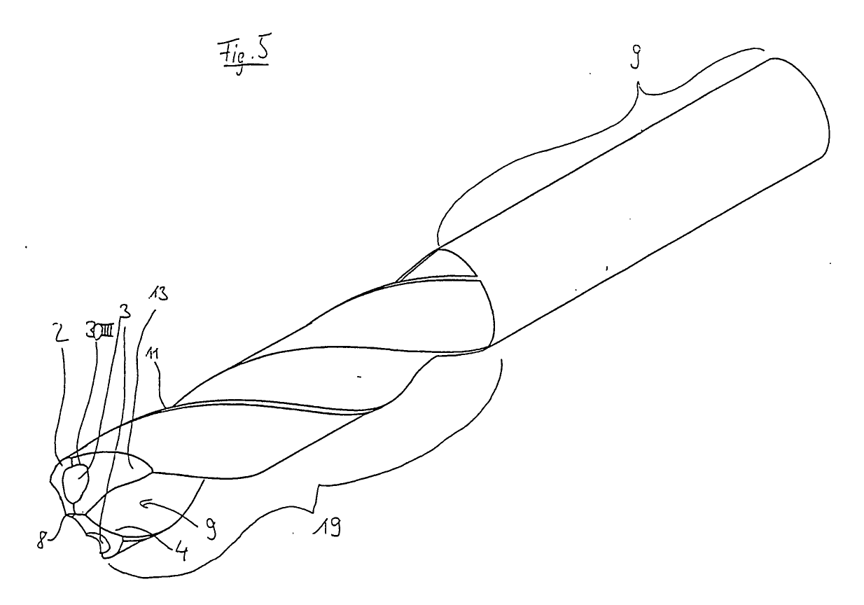

FIG. 5 shows a further embodiment of a drill according to the invention, which drill corresponds to that shown in FIG. 4 except for the changed cooling channel contour. A comparison of the cooling channel contour 30III of FIG. 5 and the cooling channel contour 30I of FIG. 4 readily shows the potential of coolant throughput that can be achieved by increasing the cross section of the cooling channels 3. To further improve the chip removal flow it is also imaginable to design the cutting grooves 1 in such a way that starting from the drill tip they widen towards the shaft of the drill.

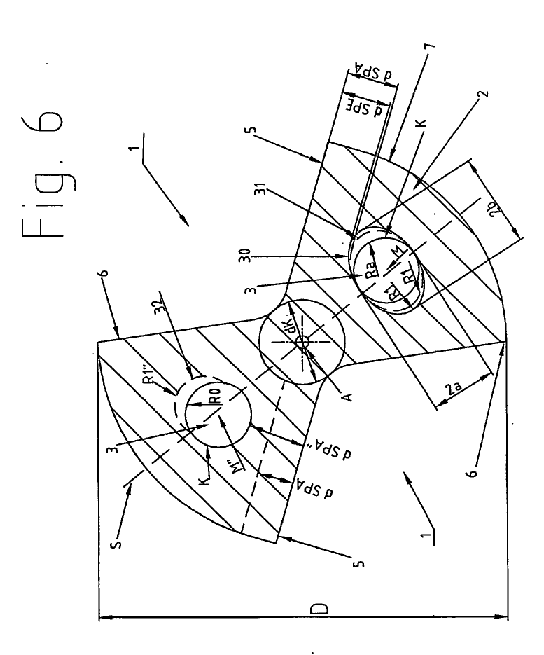

Apart from increasing the overall cross-sectional area of the cooling channels an intelligent selection of the cross-sectional contour can also bring about optimal throughput, as is shown by way of example in the cooling channel cross sections shown in FIGS. 6, 7 and 8.

Reference is now made to FIG. 6 which shows an enlarged cross-sectional view of a double cutting drill with a nominal diameter of 4 mm, comprising two stays 2 and two cutting grooves 1. On the cutting side, the stays 2 are delimited by a cutting face 5, while on the non-cutting side they are delimited by a cutting flank 6. The external circumference of the drill is designated 7.

Starting with a drill core of a diameter d_{K}, the cutting face 5 and the cutting flank 6 widen the stays 2 to such a stay width that the nominal diameter D of the drill is reached.

The stays 2 are approximately symmetrical in relation to a stay center line S, which in the drawing is shown radially in relation to the drill axis A. On the symmetry line S on the lower stay 2 there is the center M of a circle K which is located completely within the cross-sectional area of the respective cooling channel hole 3. On the upper stay there is the center M″ of the respective circle K of the same diameter 2R₀, slightly displaced away from the cutting face towards the rear, located completely within the cross-sectional area of the respective cooling channel hole 3.

In the above process, several cooling channel contours 30, 31, 32, which surround the respective cooling channel, were compared with each other according to various embodiments of the invention. The lower stay shows an elliptical contour 30 of the cooling channel 3 in a solid line, and a further contour 31 of the cooling channel 3 in a dashed line. On the upper stay, a contour 32 of the cooling channel 3 is shown in a dashed line.

In this arrangement the cooling channel contours 30, 31 have a symmetrical shape in relation to the line of symmetry, while the cooling channel 32 deviates from the contour defined by the tangentially enclosed circle K only on the non-cutting side. At the curvature maxima, there are the respective radii of curvature R₁, R₁′ and R₁″, wherein the contours 30, 31 comprise two equally curved curvature maxima while contour 32 has only one curvature maximum with a radius R₁″.

The figure shows that using the cooling channel cross-sectional geometry according to the invention while maintaining the same distance to the core diameter d_{K}, which distance cooling channel holes of circular diameter 2R₀ would have, a significant increase in the throughput area in the regions of the cooling channel, which regions of the cooling channel face the cutting face or the cutting flank, can be achieved.

In this arrangement the gain in throughput area is only limited by the minimum wall thicknesses that have to be observed, wherein for the sake of clarity the figure only shows the minimum wall thickness d_{SPE}, d_{SPA} and d_{SPA}″—which is particularly important to provide breakage resistance to the drill—between the cooling channel 3 and the cutting face 5 in relation to each of the cooling channel contours 30, 31, 32.

In turn, the minimum wall thicknesses are only prescribed by the minimum strength which the drill is to attain, and thus also by the radii R₁ or R₁′ or R₁″ at the curvature maxima of the respective cooling channel contour 30, 31, 32. This is reflected in that for the elliptical cooling channel contour 30 it is possible to use a lesser minimum wall thickness d_{SPE} than for the cooling channel contours 31, 32 with outward-displaced curvature maxima (minimum wall thickness d_{SPA}).

In this arrangement, the cooling channel contours 30, 31 maintain the minimum wall thickness d_{SPE} or d_{SPA} between the cooling channel 3 and the cutting face 5, which minimum wall thickness essentially corresponds to the minimum wall thickness (no designation) between the cooling channel 3 and the cutting flank 6. In contrast to this, for example the contour 32 on the side facing the cutting face 5 has a greater minimum wall thickness d_{SPA}″ than on the side facing away from the cutting face 5. For, on the one hand the center M′ of the enclosed circle is displaced away from the cutting side, and on the other hand the cooling channel contour 32 has a curvature maximum (radius R₁″) only on the side facing the cutting flank 6. However, it is also imaginable to provide cooling channel cross sections in which the curvature maximum is located on the side facing the cutting face.

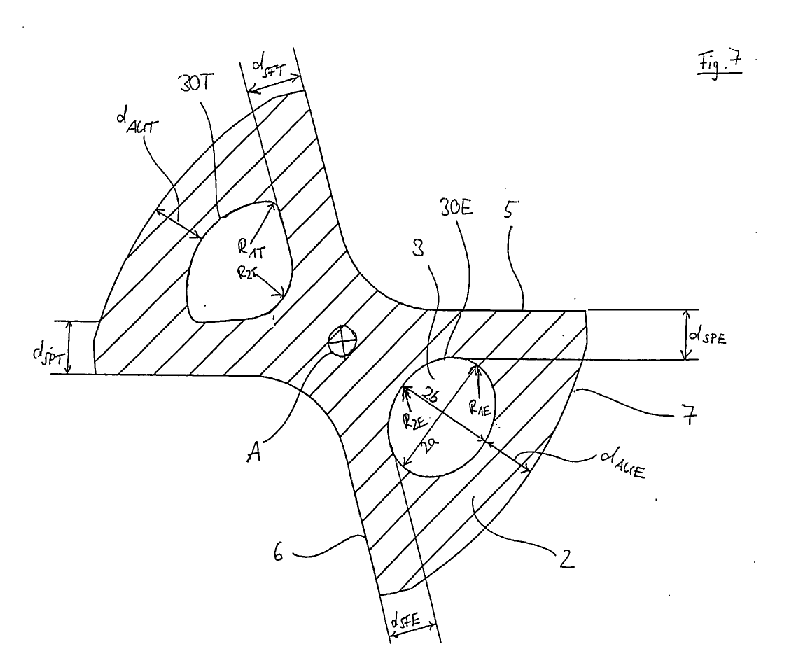

FIG. 7 shows a cross section of a double cutting drill, wherein on the upper stay a cooling channel 3 with a trigonal cooling channel profile 30T contrasts with an elliptical cooling channel profile 30E on the lower stay.

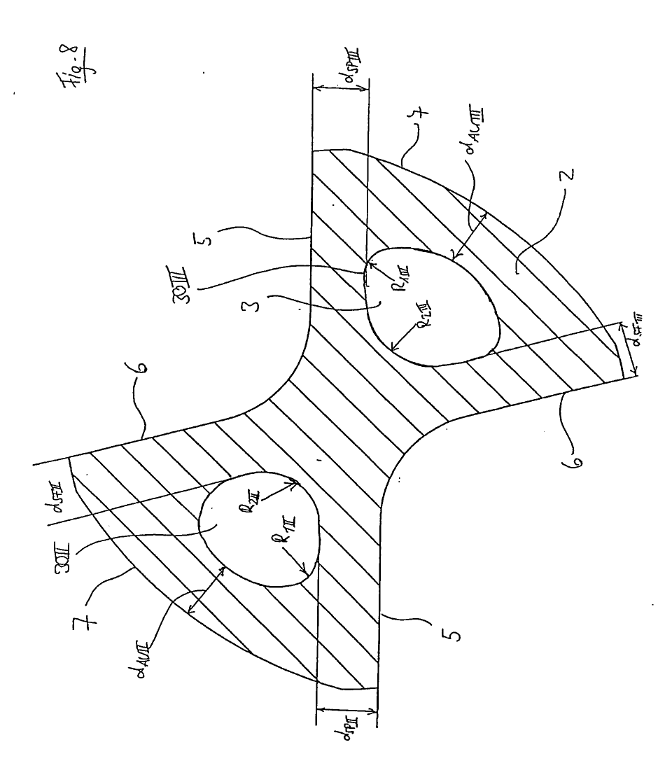

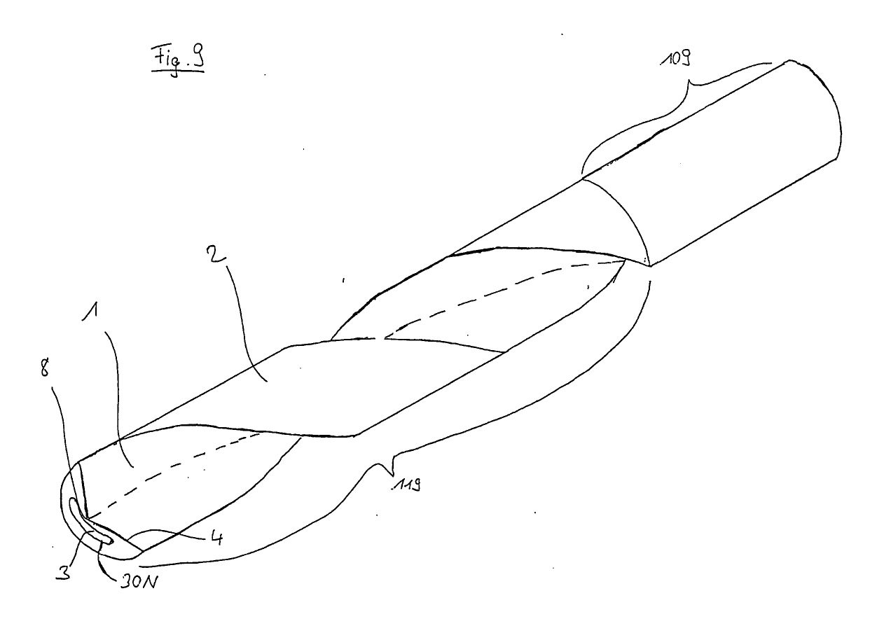

FIG. 8 also shows a cross section of a double cutting drill, wherein two further cooling channel profiles 30II, 30III are shown.

The designations d_{SPX}, d_{SFX} and d_{AUX} designate the respective minimum wall thicknesses between the cooling channel 3 and the cutting face 5, between the cooling channel 3 and the cutting flank 6, and between the cooling channel 3 and the external circumference 7, while R_{1X} and R_{2X} in each case designate the tightest and the widest radius of the cooling channel contour, wherein X represents E, T, I, II, III.

The cross sections shown in FIGS. 6 to 7 are enlarged views of a drill with a nominal diameter of 4 mm, wherein the cooling channel profiles describe the same circle with radius R₀.

In this arrangement the cooling channels comprise the following parameters:
enclosed circle with R₀=0.4, cross-sectional area 0.50 mm²;
elliptical cooling channel profile 30E with main axis 2a=0.55 mm, secondary axis 2b=0.4 mm, cross-sectional area 0.69 mm²;
approximately elliptical cooling channel profile 30II with tightest radius R_{1II}=0.3 mm, widest radius R_{2II}=0.5 mm, cross-sectional area 0.67 mm²;
approximately elliptical cooling channel profile 30III with tightest radius R_{1III}=0.2 mm, widest radius R_{2III}=0.5 mm, cross-sectional area 0.66 mm²; and
trigonal cooling channel profile with tightest radius R_{1T}=0.1 mm, widest radius R_{2T}=0.4 mm, cross-sectional area 0.65 mm².

The figures show that the cross-sectional area of the enclosed circle is clearly smaller than that of the other cooling channels, while the cross-sectional areas of the remaining cooling channels are almost identical in size.

Trials and simulations on the drills shown in FIGS. 6 to 8 have also shown that as a result of greater radius rounding at the curvature maximum a reduction in the stress concentration in the cooling channel of the tool which is subjected to pressure loads and torsional loads can be achieved. The best values were achieved with the elliptical profile 30E, while in the trigonal profile dramatically increased stress peaks had to be accepted.

FIGS. 9 to 13 show various embodiments of a single-lip drill tool according to the invention.

The single-piece drill tool shown in FIG. 9 has a spiral cutting groove designated 1 and a spiral stay designated 2, both extending from the drill tip 8 through the cutting part 119 to the drill shaft 109.

The stay 2 comprises a main cutter 4 which extends from the tool circumference to the tool axis which on the tool tip 8 coincides with the spiral shape (shown in a dashed line) of the cutting groove 1. In the stay 2 a cooling channel 3 is formed whose kidney-shaped cross-sectional contour is designated 30N, wherein said cooling channel spirally extends at exactly the same pitch as that of the cutting groove 1 and the stay 2 through the entire tool in order to guide, during operation, a coolant forced in at the face of the drill shaft 109 directly to the tension region at the tool tip 8. The kidney-shape meets the requirements for making optimal use of the stay area so that excellent coolant supply can be ensured. Furthermore, using a kidney shape, the radii at the position of the smallest curvature are no greater than they would be with the use of two circular cooling channels with identical minimum rim distances so that increased tension peaks under load can be prevented while at the same time improved coolant throughput is achieved, wherein the coolant extends not only in points but instead along the entire cutting groove wall. It becomes clear that as a result of its spiral cutting groove 1, the drill tool shown is supported along its entire circumference in the drill hole so that better centring accuracy can be achieved than is the case in a conventional straight-grooved single-lip drill tool.

The further figures relate to modifications of the tool shown in FIG. 9.

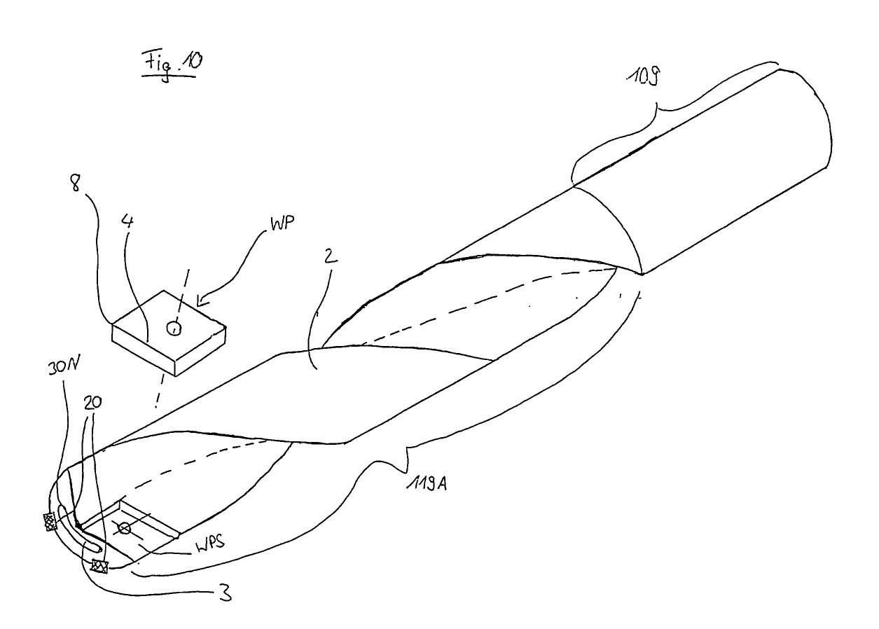

Thus, the tool shown in FIG. 10, instead of having a cutter affixed to the stay, comprises a modified cutting part 119A with a seat WPS for a cutting plate. A respective cutting plate is thus designated WP. The main cutter 4 and the drill tip 8 are provided on the cutting plate WP. On the circumferential side, guide strips 20 are provided on the tool stay 2, by which guide strips 20 the tool is supported in the drill hole. It is important that the cooling channel 3, i.e. its cross-sectional contour 30N, is arranged such that the necessary minimum wall thickness to the seat WPS of the cutting plate and to the seat of the guide strips 20 is maintained.

Due to their single-piece design, the tools shown in FIGS. 9 and 10 are not weakened by connection joints between individual elements. For reasons of cost and in order to meet the various requirements concerning drill tip and tool length, deep-drill tools are often produced from several parts wherein the materials used for the drill head and the drill shaft often differ from the materials used for the remaining cutting part. For example, an extremely hard hard-metal is suited for use in the drill head, while for the cutting part, where toughness is the primary requirement, often some other hard metal is used.

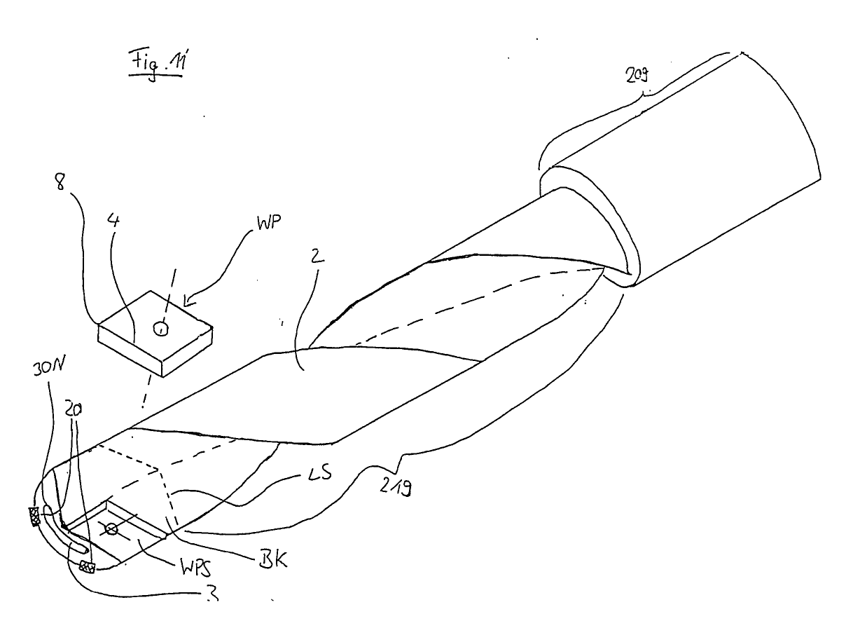

Furthermore, FIG. 11 shows a tool comprising several components. In this arrangement a drill head BK is soldered onto a cutting part 219, wherein said drill head BK comprises the seat WPS of the cutting plate for accommodating the cutting plate WP. The dashed line indicates the soldering joint LS. The cutting part 219 is again soldered into a clamping shaft 209. In this arrangement the cooling channel 3 of kidney-shaped cross-sectional contour 30N extends spirally through the drill head BK and the cutting part 219, wherein in the shaft 209 a straight cooling channel connection piece between the cutting part 219 on the one hand, and the machine-side coolant supply on the other hand can be provided.

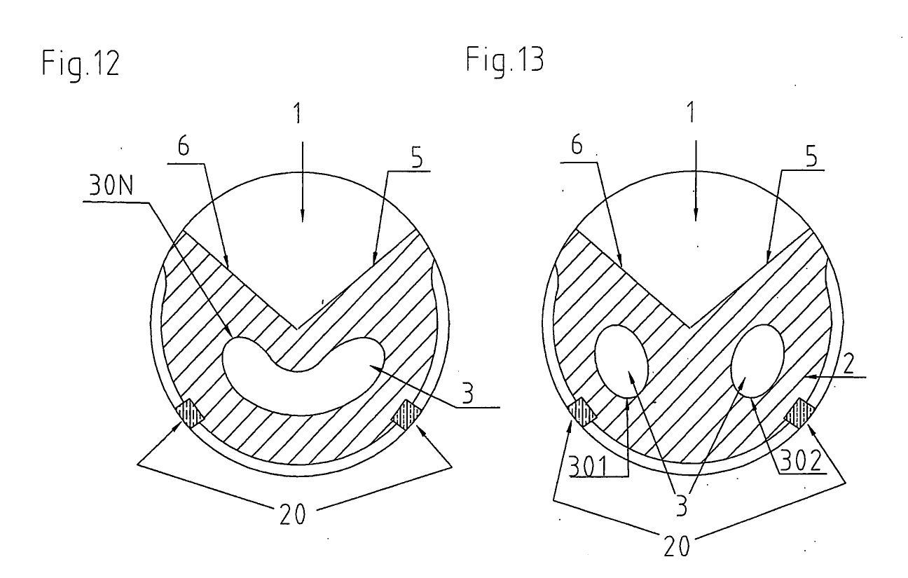

Finally, FIGS. 12 and 13 are cross-sectional views of two single-lip drills according to the invention. The figures show that the cutting groove 1 accounts approximately for a quarter of the space available on the drill diameter, while the stay 2 accounts for approximately three quarters. In these arrangements, the cooling channel 3 of the tool shown in FIG. 12 comprises the kidney-shaped contour 30N that has already been discussed above, while the drill tool shown in FIG. 13 comprises two cooling channels 3, each comprising free form contours 301,302 that approximately correspond to distorted ellipses. In each case two guide strips are shown on the circumferential side. The guide strips 20 are thus longer than the associated cutting plate and follow the tool stay in a spiral shape. In this way circumferential support in the drill hole is provided, which support extends all around a particular circumferential region.

Of course, deviations from the embodiments shown are possible without thereby leaving the idea on which the invention is based.

1. An extrusion press method for the continuous production of fully cylindrical sintered blanks formed of plastic material and comprising at least one internal, spirally extending channel having a predetermined cross-section, said method comprising:
pressing plastic material (out of a mouth of a nozzle of an extrusion press on an outlet side thereof in the form of a substantially circular cylindrical pipe, said plastic material flowing along an axis of at least one spirally twisted pin which is maintained in a stable position on a gudgeon of the nozzle, which pin protrudes at least sectionally into the mouth of the nozzle, said plastic material entering the mouth of the nozzle in an essentially twist-free manner,
the plastic material in the mouth of the nozzle being displaced in a twisted flow corresponding to a spiral shape of the spirally twisted pin; and
rotationally driving a section of the mouth of the nozzle, which is engaged on an outer periphery of the plastic material to support rotational movement of the plastic material, said pin not being rotated, such that the pin is essentially not subjected to any bending deformation.

2. The extrusion press method according to claim 1, wherein a rotary driven section of the mouth of the nozzle extends at least in sections along the section penetrated by the pin.

3. The extrusion press method according to claim 1, wherein a fluid or fluid-like substance, which reduces the frictional force of the plastic material, is fed to the at least one pin.

4. A fully cylindrical sintered blank, comprising at least one spirally formed channel whose cross-sectional contour diverges perpendicularly to a longitudinal axis of the blank from a circular contour, a diameter (D) of the blank being less than 12 mm.

5. A fully cylindrical sintered blank, comprising at least one spiral-shaped formed channel,
a ratio of a cross-sectional area of a channel arranged in a plane which is substantially perpendicular to an axis of said blank to a cross-sectional area of a remaining material being at least 0.20.

6. The sintered blank according to claim 5, wherein said ratio is at least 0.30.

7. The sintered blank according to claim 4, wherein a deviation of a spiral shape of said spirally formed channel from a helix at a blank length of 100 mm is at most 10′ at any position.

8. The sintered blank according to claim 4, wherein a blank length exceeds 300 mm.

9. The sintered blank according to claim 4, wherein a ratio of a diameter of said sintered blank to a length of said sintered blank is not greater than 0.20.

10. The sintered blank according to claim 4, wherein an angle of said spiral exceeds 10°.

11. The sintered blank according to claim 4, wherein said cross-sectional contour of the channel is delimited by two lateral sections which are substantially straight in at least some sections.

12. The sintered blank according to claim 4, wherein said cross-sectional contour of the channel tangentially encloses an imaginary circle with a center and comprises at least one curvature maximum whose distance from the longitudinal axis of the blank in the direction of a line between the center and the longitudinal axis is equal to or greater than a distance between the center and the longitudinal axis.

13. The sintered blank according to claim 4, wherein said cross-sectional contour of the channel tangentially encloses an imaginary circle with a center and comprises at least two curvature maxima, and said two curvature maxima of the cross-sectional contour of the channel have substantially identical radial coordinates.

14. The sintered blank according to claim 4, wherein a cross-sectional area of the channel is symetrical to a line extending radially from said axis.

15. The sintered blank according to claim 11, wherein a radius at the tightest curvature of the cross-sectional contour of the channel corresponds to 0.35 times to 0.9 times the radius of the circular contour.

16. The sintered blank according to claim 4, wherein said channel has a substantially kidney-shaped cross-sectional contour.

17. The sintered blank according to claim 4, wherein said channel has a substantially elliptical cross-sectional contour.

18. The sintered blank according to claim 4, wherein said channel has a substantially trigonal cross-sectional contour.

19. A rotary driven cutting tool comprising a shaft and a cutting part, said cutting tool having at least one spiral cutting groove and at least one stay, at least one spiral internal cooling channel being provided in said stay, said channel extending from the drill tip to an opposite face of the shaft.

20. The cutting tool according to claim 19, wherein said tool comprises a single-piece.

21. The cutting tool according to claim 19, wherein said tool is a two-lip tool or a multliple-lip tool.

22. The cutting tool according to claim 19, wherein said tool is a single-lip tool.

23. The cutting tool according to claim 19, wherein minimum wall thicknesses d_{AUX}, d_{SPX}, d_{SFX} between the internal cooling channel and an external circumference of the drill; between the internal cooling channel and a cutting face; and between the internal cooling channel and a cutting flank are within a lower limit and an upper limit, wherein
the lower limit is 0.08×D for D<=1 mm, and 0.08 mm for D>1 mm, D being equal to a diameter of said cutting tool, and wherein
the upper limit is 0.35×D for D<=6 mm, and 0.4×D−0.30 mm for D>6 mm (W_{max, 1}).

24. A cylindrical component of a multi-piece cutting tool comprising at least one spiral cutting groove, at least one stay, and at least one spiral cooling channel which extends through the entire component, said component having been produced from a sintered blank according to claim 4.

25. The component according to claim 24, wherein said component comprises more than one cutting groove.

26. The component according to claim 24, wherein said component comprises one cutting groove.
